(19) United States
(12) Patent Application Publication
(10) Pub. No.: US 2010/0131594 A1
(43) Pub. Date: May 27, 2010

(54) WEB PAGE ACCESS METHOD AND SERVER

(76) Inventor: Shinichi Kashimoto, Hino-shi (JP)

Correspondence Address: BLAKELY SOKOLOFF TAYLOR & ZAFMAN LLP, 1279 OAKMEAD PARKWAY, SUNNYVALE, CA, 94085-4040, US

(21) Appl. No.: 12/622,180

(22) Filed: Nov. 19, 2009

(30) Foreign Application Priority Data
Nov. 21, 2008 (JP) 2008-298545

(51) Int. Cl. G06F 3/01; G06F 15/16

(52) U.S. Cl. 709/203; 715/760

(57) ABSTRACT

According to one embodiment, of the invention, there is provided a Web page access method applied to a network system. The network system comprises a terminal having a Web page browsing function, and a server that stores a Web page accessible from the terminal. The access method includes determining, by the server, characteristics of a user interface of an access source terminal, generating, by the server, a modified Web page by modifying a reference method of a link on the Web page according to the determined characteristics, transmitting, by the server, the modified Web page to the access source terminal, and displaying, by the terminal, the transmitted modified Web page.

### CROSS-REFERENCE TO RELATED APPLICATIONS

This application is based upon and claims the benefit of priority from Japanese Patent Application No. 2008-298545, filed Nov. 21, 2008, the entire contents of which are incorporated herein by reference.

### BACKGROUND

1. Field

One embodiment of the present invention relates to an improvement of a method of accessing content published on an Internet Protocol (IP) network. That is, the invention is most suitably applied to accesses from a terminal having a Web browser function to a Web page on the World Wide Web.

2. Description of the Related Art

In recent years, not only personal computers but also some mobile phones and personal digital assistants (PDAs) have a browser function. An advanced mobile phone called a “Smartphone”, which merges a mobile phone or personal handyphone system (PHS) terminal and PDA, also has a browser function.

In order to operate a browser or to designate a link destination, a pointing device such as a mouse is exclusively used. However, most of the aforementioned terminals such as a Smartphone do not have any browser operation User Interface (UI). Also, not all computer terminals have a browser operation UI. Hence, a device that allows operation of a browser without using a mouse has been produced (see Jpn. Pat. Appln. KOKAI Publication No. 2002-373040 and Jpn. Pat. Appln. KOKAI Publication No. 10-39981).

For example, a Web page description language called XHTML includes syntaxes called an access key attribute (accesskey attribute [XHTML 1.0]) and access element (access element [access tag: XHTML 2.0]). On a Web page described using these languages, the user can jump to a link destination by means of a shortcut key on a computer keyboard. Note that XHTML is a language realized by re-defining Hypertext Markup Language (HTML) to comply with the requirements of Extended Markup Language (XML).

For example, a Web page that describes (H) as an access key for a link used to return to a homepage (home) will be examined below. On a standard browser, the user can return to home by simultaneously pressing the ALT key and H key. However, in order to inform the user of this operation that allows the user to return to home, a message that advises accordingly has to be additionally described on the Web page.

A Web page has to be designed so that operations unique to that Web page do not conflict with shortcut keys of the browser itself. For example, on general browser software, “ALT+F” is a shortcut to “File” in the menu bar. Hence, the Web page has to be designed not to use “ALT+F” to access a link.

Furthermore, a Web page browsable by a browser on, e.g., the Smartphone is normally described using a language of a standard unique to a given carrier. Languages of Japanese carriers support an access key standard. For example, a Web page that describes “1” as an access key used to return to home will be examined below. In this case, in order to inform the user of “press “1” to return to home”, a message that advises accordingly has to be additionally described on the Web page. Also, a Web designer has to optimally select a numeral assigned to the access key. For example, the Web designer has to select keys so that 10 or fewer numerals from 0 to 9 are laid out within a Web page that can be browsed without scrolling.

As described above, use of an access key allows the user to enjoy browsing the Web without using a pointing device, but it poses a unique problem upon designing a Web page. That is, an access key is required to be described as metadata within a Web page, so as to make Web client software recognize the access key. Also, data which informs the user of the relationship between access keys to be pressed and links to be referred to is required to be described within the Web page. Furthermore, a Web client is required to include a function of determining an access key from an HTML tag, and requesting a Web server to jump to a link corresponding to the input access key. If these requirements are not satisfied, a Web client without a pointing device can only access a desired link by sequentially tracing links in a Web page. In this way, a Web page access method based on the existing technique is not user-friendly.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is a diagram showing an example of a network system to which a Web page access method according to the invention is applicable;

FIG. 2 is a view showing an example of the outer appearance of a network terminal 300;

FIG. 3 is a view showing an example of the outer appearance of a Smartphone 400;

FIG. 4 is a functional block diagram showing an embodiment of a Web server 100 shown in FIG. 1;

FIG. 5 is a view showing an example of a management database 14a; and

FIG. 6 is a flowchart showing an example of the processing sequence of the Web server 100 according to an embodiment of the invention.

### DETAILED DESCRIPTION

Various embodiments according to the invention will be described hereinafter with reference to the accompanying drawings. In general, according to one embodiment of the invention, there is provided a Web page access method applied to a network system. The network system comprises a terminal having a Web page browsing function, and a server that stores a Web page accessible from the terminal. The access method includes: determining, by the server, characteristics of a user interface of an access source terminal; generating, by the server, a modified Web page by modifying a reference method of a link on the Web page according to the determined characteristics; transmitting, by the server, the modified Web page to the access source terminal; and displaying, by the terminal, the transmitted modified Web page.

By taking such means, upon reception of an access request from a terminal, the server determines the characteristics of a terminal user interface such as the presence/absence of a mouse and the presence/absence of a numeric keypad. The server generates a modified Web page by modifying a reference method of a link destination on an existing Web page based on the determination result. For example, to a terminal which does not have any mouse but has a numeric keypad, a Web page code that allows designation of a link destination using a number is transmitted. As a result, the user can jump to a desired Web page without any operations for sequentially tracing link destinations, thus greatly improving user convenience.

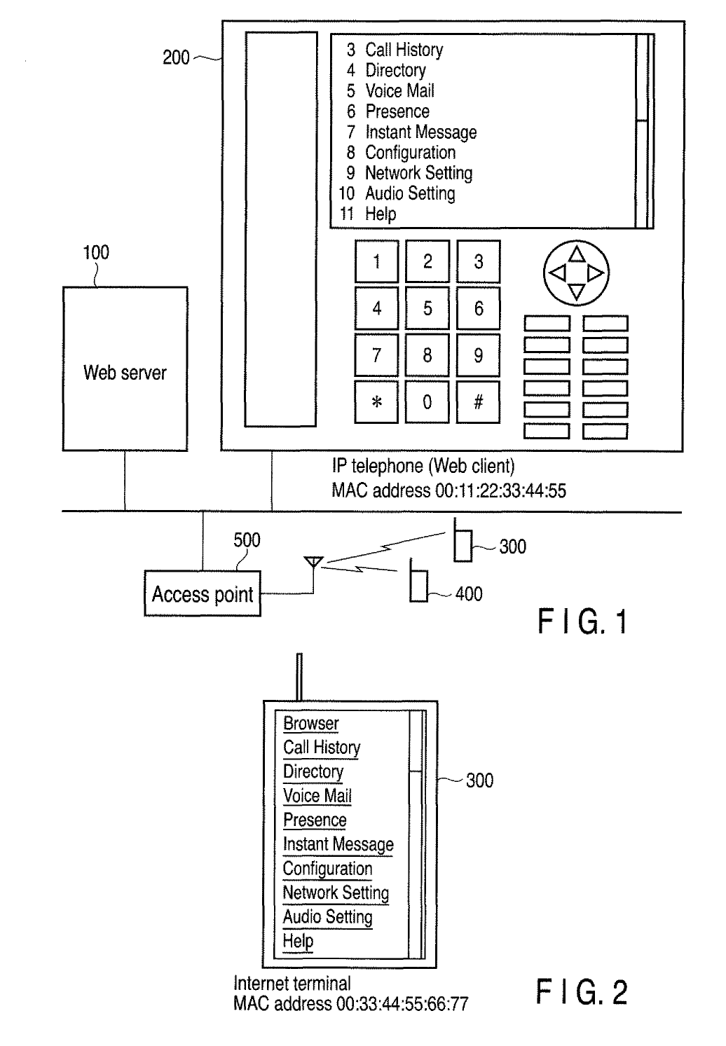

FIG. 1 is a diagram showing an example of a network system to which a Web page access method according to the invention is applicable. Principal objects which form this system are a Web server 100 and Web clients. The Web clients are functional objects which respectively run on an IP telephone 200, Internet terminal (to be referred to a network terminal hereinafter) 300, and Smartphone 400, and have unique identification information. In this embodiment, each individual Web client is distinguished using a Media Access Control (MAC) address as identification information of a terminal.

The network terminal 300 includes a portable information terminal, personal computer, PDA, and the like. The network terminal 300 and Smartphone 400 can access the Web server 100 via, for example, an access point 500.

The IP telephone 200 as the Web client has an outer appearance, as shown in, e.g., FIG. 1. The IP telephone 200 includes a display such as a liquid crystal display (LCD), and can display a Web page acquired from the Web server on this display. The size of the display is smaller than a computer monitor, but the display can display desired information by scrolling a screen.

Normally, since a telephone terminal does not have a pointing device, the user cannot click a link displayed within this screen. However, by inputting a number assigned to each link, the user can select and designate the link. FIG. 1 shows links such as “03 Call History”, “04 Directory”, and so forth. Assume that the MAC address of this IP telephone 200 is “00:11:22:33:44:55”.

The network terminal 300 as the Web client has an outer appearance shown in FIG. 2, if it is, for example, a PDA. The PDA has a display unit having a relatively large size and a screen scroll function, and can display many pieces of information. FIG. 2 shows a state in which a Web page having a large number of links is displayed, and each link can be clicked using a pointing device such as a touch pen. Assume that the MAC address of this network terminal 300 is “00:33:44:53:66:77”.

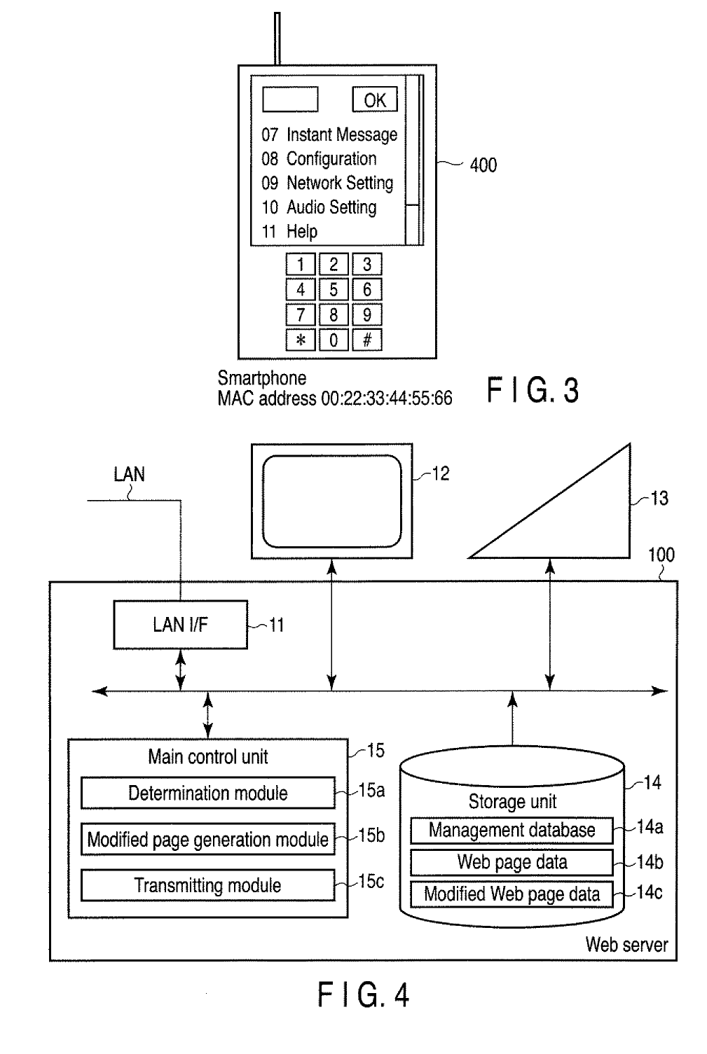

The Smartphone 400 as the Web client has an outer appearance, as shown in, e.g., FIG. 3. The Smartphone 400 does not have a pointing device but it has a numeric keypad that allows numerical input. A display unit of the Smartphone 400 is to be smaller than the network terminal 300 but it can display required information by scrolling the screen. Assume that the MAC address of this Smartphone 400 is “00:22:33:44:55:66”.

FIG. 4 is a functional block diagram showing an embodiment of the Web server 100 shown in FIG. 1. The Web server 100 includes an interface unit 11, display unit 12, input/output unit 13, storage unit 14, and main control unit 15. The interface unit 11 is connected to a LAN and executes processing associated with exchange of packets. The display unit 12 provides a user interface together with the input/output unit 13, and realizes a graphical user interface (GUI) environment.

The storage unit 14 is a storage device such as a hard disk drive, and stores a management database 14a, Web page data 14b, and modified Web page data 14c.

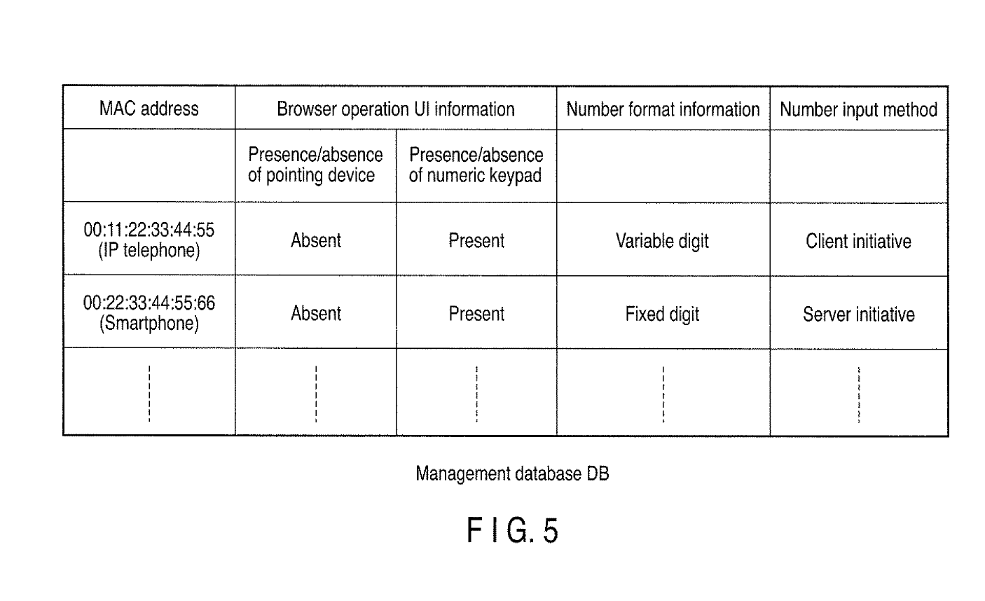

FIG. 5 is a view showing an example of the management database 14a. This database associates the MAC addresses of the respective terminals with the characteristics of their user interfaces. The user interface characteristics include items [browser operation UI information], [number format information], and [number input method].

The item [browser operation UI information] indicates information required to distinguish whether or not a terminal of interest includes a pointing device such as a touch panel or mouse. That is, this item indicates information required to distinguish whether or not the terminal of interest includes a human-machine interface used to operate a link, pointer, and the like displayed on the screen. In FIG. 5, the corresponding fields of both the IP telephone 200 and Smartphone 400 include “absent”. Furthermore, the item [browser operation UI information] includes information indicating whether or not the terminal of interest has a numeric keypad. In FIG. 5, the corresponding fields of both the IP telephone 200 and Smartphone 400 include “present”.

The item [number format information] is information indicating the format of numbers assigned to links on a Web page. That is, this information is used to distinguish whether the number of digits of a number beside each displayed link is fixed or variable. That is, letting n be the number of digits of the number of links per Web page, this information can distinguish whether numbers of n digits (fixed) are assigned or numbers of variable digits like 1, 2, . . . n digits are assigned.

In FIG. 5, the IP telephone 200 has a variable digit setting, which corresponds to FIG. 1. That is, the digits of numerals beside links displayed on the IP telephone 200 are carried up like 1, 2, 3, . . . , 9, 10, and 11. In contrast, the Smartphone 400 has a fixed digit setting (FIG. 5), which corresponds to FIG. 3. That is, the number of digits of numerals beside links displayed on the Smartphone 400 is fixed like 01, 02, . . . , 10, and 11.

The item [number input method] is information required to distinguish whether a link destination is designated using a numeral beside each link at the initiative of a client or server. With a method at the initiative of the Web server 100, the Web server 100 adds an HTML FORM tag to, e.g., the head of a Web page. Then, a Web client can be controlled to display a text box used to input information. With a method at the initiative of a Web client, a number input by the user while the Web client displays a Web page on which numbers are added to links is determined as a link destination designation input.

The management database 14a may register the contents of FIG. 5 in the Web server 100 by manual inputs of a system operator. Alternatively, each Web client may notify the Web server 100 of the information shown in FIG. 5 together with its MAC address, and the Web server 100 that received the information may build up the management database 14a. Also, these methods may be selected depending on a terminal on which the Web client runs. For example, in this embodiment, the following method is adopted.

As for the IP telephone 200, its Web client notifies the Web server 100 of the information shown in FIG. 5, and the Web server 100 builds up the management database 14a. Notification of the information to the Web server 100 can use a versatile method (e.g., the information may be inserted in (uniform resource locator [URL] parameters or in an http Body part). As for the Smartphone 400, the information shown in FIG. 5 is registered in the Web server 100 by operator's manual inputs. Note that as for the network terminal 300, these pieces of information are not registered in the Web server 100. As for a terminal whose record is not registered in the management database 14a, the Web server 100 assumes that the terminal has a pointing device.

Referring back to FIG. 4, the Web page data 14b in the storage unit 14 is that accessible from a terminal having a Web client, and is, for example, a document file described using XHTML. The modified Web page data 14c is data obtained by modifying the Web page data 14b, and is especially data obtained by modifying a link reference method in the original Web page data 14b.

The main control unit 15 includes a determination module 15a, modified page generation module 15b, and transmitting module 15c as its processing functions.

The determination module 15a determines the characteristics of a user interface of a terminal which accessed the Web page data 14b (access source terminal). That is, the determination module 15a refers to the management database 14a using the MAC address of the access source terminal as a key to determine the characteristics of the user interface of this access source terminal in correspondence with the items [browser operation UI information], [number format information], and [number input method].

The modified page generation module 15b generates the modified Web page data 14c by modifying the link reference method on the Web page according to the characteristics determined by the determination module 15a. This modified Web page data 14c is saved in the storage unit 14. Especially, when the determined characteristics indicate “the absence of a pointing device” and “the presence of a numeric keypad”, the modified page generation module 15b generates a modified Web page that allows the user to refer to link destinations by numbers that can be input using the numeric keypad. In fact, the numbers that can be input using the numeric keypad are those beside links, as shown in FIGS. 1 and 3.

The transmitting module 15c transmits the modified Web page data 14c to the access source terminal. When a Web page does not require any modification, the transmitting module 15c transmits the Web page data 14b intact to the access source terminal (client). Operations in the above arrangement will be described below.

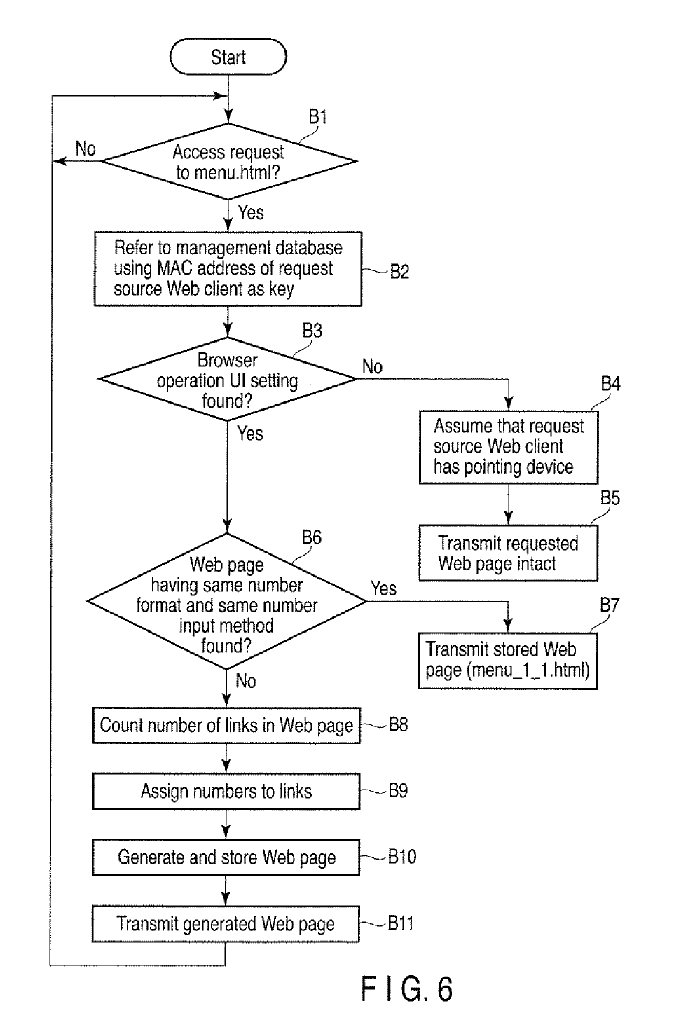

FIG. 6 is a flowchart showing an example of the processing sequence of the Web server 100 according to this embodiment. Assume that an access request to a Web page is issued from a Web client to the Web server 100 in FIG. 6 (Yes in block B1). Also, assume that the file name of this Web page is, for example, (menu.html). Then, the Web server 100 refers to the management database 14a using the MAC address of the request source Web client as a key to acquire its browser operation UI information (block B2).

Table 1 shows an example of a source code of the menu.html.

TABLE 1

<html>
<head>
<title>Menu</title>
</head>
<body>
<a href=“Telephone.html”>Telephone</a><br>
<a href=“Browser.html”>Browser</a><br>
<a href=“CallHistory.html”>Call History</a><br>
<a href=“Directory.html”>Directory</a><br>
<a href=“Presence.html”>Voice Mail</a><br>
<a href=“Presence.html”>Presence</a><br>
<a href=“InstantMessage.html”>Instant Message</a><br>
<a href=“Configuration.html”>Configuration</a><br>
<a href=“AudioSetting.html”>Network Setting</a><br>
<a href=“AudioSetting.html”>Audio Setting</a><br>
<a href=“Help.html”>Help</a><br>
</body>
</html>

If the access source terminal is the network terminal 300, its MAC address is not registered in the management database 14a (No in block B3). Hence, the Web server 100 assumes that the network terminal 300 has a pointing device (block B4). The Web server 100 does not generate any modified Web page data 14c in response to an access from a device of this type. That is, the Web server 100 transmits the requested Web page data 14b in the state of Table 1 intact without assigning any numbers to links of the Web page data 14b or appending any number input method (block B7).

In contrast, as for accesses from the IP telephone 200 and Smartphone 400, the MAC addresses of these terminals are registered in the management database 14a, and the Web server 100 can find out their browser operation UI settings (Yes in block B3). Hence, the Web server 100 identifies this access as that from a terminal which does not have a pointing device. In response to an access from a terminal of this type, the Web server 100 generates the modified Web page data 14c by assigning numbers to links on a Web page based on the number format and appending a number input method based on the number input method.

Note that before generating the modified Web page data 14c, the Web server 100 checks whether the modified Web page data to be served is already stored in the storage unit 14 (block B6). If the modified Web page data to be served is not stored (No), the Web server 100 executes generation of the modified Web page data 14c.

More specifically, the Web server 100 counts the number of links in the Web page of Table 1 (block B8). In this case, the number of links is 11. Next, the Web server 100 assigns serial numbers to the counted individual links (block B9). The number format of the IP telephone 200 is “variable digit” (see FIG. 5). Hence, the Web server 100 assigns numbers 0, 1, . . . , 9, and 10 to links in the modified Web page data 14c for the IP telephone 200. The number format of the Smartphone 400 is “fixed digit”. Hence, the Web server 100 assigns numbers 00, 01, . . . , 09, and 10 to links in the modified Web page data 14c for the Smartphone 400.

Table 2 shows an example of a source code of the modified Web page data 14c. This source code corresponds to a case in which the number format information is “variable digit”, and its file name is (menu_{—}1_{—}1.html).

TABLE 2

<html>
<head>
<title>Menu</title>
</head>
<body>
<a href=“Telephone.html”>0 Telephone</a><br>
<a href=“Browser.html”>1 Browser</a><br>
<a href=“CallHistory.html”>2 Call History</a><br>
<a href=“Directory.html”>3 Directory</a><br>
<a href=“Presence.html”>4 Voice Mail</a><br>
<a href=“Presence.html”>5 Presence</a><br>
<a href=“InstantMessage.html”>6 Instant Message</a><br>
<a href=“Configuration.html”>7 Configuration</a><br>
<a href=“AudioSetting.html”>8 Network Setting</a><br>
<a href=“AudioSetting.html”>9 Audio Setting</a><br>
<a href=“Help.html”>10 Help</a><br>
</body>
</html>

Table 3 shows another example of a source code of the modified Web page data 14c. This source code corresponds to a case in which the number format information is “fixed digit”, and its file name is (menu_{—}2_{—}2.html).

TABLE 3

<html>
<head>
<title>Menu</title>
</head>
<body>
<form method=“get” action=“menu.php”>
<input type=“text” number=“number” >
<input type=“submit” value=“OK” >
<a href=“Telephone.html”>00 Telephone</a><br>
<a href=“Browser.html”>01 Browser</a><br>
<a href=“CallHistory.html”>02 Call History</a><br>
<a href=“Directory.html”>03 Directory</a><br>
<a href=“Presence.html”>04 Voice Mail</a><br>
<a href=“Presence.html”>05 Presence</a><br>
<a href=“InstantMessage.html”>06 Instant
Message</a><br>
<a href=“Configuration.html”>07 Configuration</a><br>
<a href=“AudioSetting.html”>08 Network Setting</a><br>
<a href=“AudioSetting.html”>09 Audio Setting</a><br>
<a href=“Help.html”>10 Help</a><br>
</body>
</html>

The Web server 100 generates the modified Web page data (block B10). Both of the codes of Tables 2 and 3 are stored in the storage unit 14 to have new file names. The Web server 100 transmits the modified Web page data to the request source client (block B11).

In this case, a file name obtained by adding, to the original Web page data file name (menu.html), indices that indicate differences of the number format and number input method is preferably given to each code data. For example, “variable digit” and “fixed digit” of the number format are respectively identified by indices “1” and “2”, and “client initiative type” and “server initiative type” of the number input method are respectively identified by indices “1” and “2”. Then, a file name “menu_{—}1_{—}1.html” is given to the Web page of Table 2, and a file name “menu_{—}2_{—}2.html” is given to the Web page of Table 3.

In block B6 of FIG. 6, the Web server 100 searches for a Web page (menu_*_*.html) held for each number format and number input method. If a Web page having the same number format and the same number input method (modified Web page data 14c) is stored in the storage unit 14 (Yes), the Web server 100 reads this data, and transmits the read data to the request source client (block B7). With this sequence, the need for another data modification can be obviated. That is, data “menu_*_*.html” need not be repetitively generated. As a result, the processing load on the Web server 100 can be reduced.

In a case in which the IP telephone 200 accesses the Web page of Table 1, code data (modified Web page data) returned to this IP telephone 200 is as shown in Table 2. In a case in which the Smartphone 400 accesses the Web page of Table 1, modified Web page data returned to this Smartphone 400 is as shown in Table 3. The number format and input method of numbers assigned to links bring about this difference. These pieces of information are managed using the management database 14a.

Note that in the code returned to the Smartphone 400, an HTML tag (FORM tag) used to input a number for selecting a link is appended at its head position. This tag is a standard one. This is because the number input method of the Smartphone 400 is of Web server initiative type, and this tag is not required for the IP telephone 200 of client initiative type.

By appending the FORM tag, a number input box and OK button are displayed on the first line of the display unit of the Smartphone 400, as shown in FIG. 3. The user can input a number for selecting a link using this box from a versatile browser on the Smartphone 400.

On the IP telephone 200, no number input box is displayed (FIG. 1), and the number input method is controlled at the initiative of a Web client. That is, the Web client determines a number input by the user while the Web page is displayed, as an input to select a link. For example, the Web page of Table 2 includes “1” and “10” as numbers used to select links. These numbers have to be distinguished from each other. Hence, when no input is made for a predetermined period, i.e., a prescribed interval elapses after “1” is input using the numeric keypad, the Web client assumes that “1” is settled. When “0” is further input before a time-out, the Web client assumes that “10” is settled as an input.

The IP telephone 200 (Web client) notifies the Web server 100 of the settled link designation number using a versatile method. For example, the Web client designates the link selection number as URL parameters, and accesses a Web page written in a script language (for example, menu.php written in PHP) that processes link selection of the menu.html, thus passing the information to the Web server 100.

In the Smartphone 400 (Web client), a versatile browser processes parameters of the FORM tag (method=“get” action=“menu.php” in Table 3), thus passing the number in the number input box to the Web server 100.

As described above, according to this embodiment, in response to an access from a Web client which does not have a pointing device but has a numeric keypad, the Web server 100 generates modified Web page data in which fixed- or variable-digit numbers are assigned to links and a number input method is appended, and transmits that data to the Web client. Also, the Web server 100 stores modified Web page data 14c for respective number formats and number input methods, and transmits the held Web page in response to a second or subsequent access from the Web client having the same number format and number input method, thereby reducing the self processing load. The Web client settles a number input by the user based on the number format and number input method, and notifies the Web server 100 of the settled number.

In this manner, since the Web server 100 modifies the Web page data 14b by appending numbers and number input method required to designate links on a Web page based on the browser operation UI, number format, and number input method, the need for describing metadata and data associated with access keys in the Web page can be obviated. Even when a Web client does not have any access key processing function, the Web client which does not have a pointing device but has a numeric keypad can access a desired link without sequentially tracing links in the Web page. As described above, a user-friendly Web page access method and server can be provided.

Note that the invention is not limited to the aforementioned embodiment. For example, a Web client notifies the Web server 100 of a resolution of a display of a terminal in addition to the presence/absence of a pointing device and the presence/absence of a numeric keypad, and this information is managed together, thus allowing generation of more flexible Web page data. Also, the information shown in FIG. 5 may be saved in a cookie of a terminal, and the accessed Web server 100 may acquire the information from the cookie.

The various modules of the systems described herein can be implemented as software applications, hardware and/or software modules, or components on one or more computers, such as servers. While the various modules are illustrated separately, they may share some or all of the same underlying logic or code.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A Web page access method applied to a network system, which comprises a terminal having a Web page browsing function, and a server that stores a Web page accessible from the terminal, comprising:
determining, by the server, characteristics of a user interface of an access source terminal;
generating, by the server, a modified Web page by modifying a reference method of a link on the Web page according to the determined characteristics;
transmitting, by the server, the modified Web page to the access source terminal; and
displaying, by the terminal, the transmitted modified Web page.

2. The method of claim 1, in which the characteristics include the presence/absence of a pointing device and the presence/absence of a numeric keypad, and
which further comprises generating, by the server, a modified Web page that allows reference to the link by a number to be input by the numeric keypad when the determined characteristics indicate “the absence of a pointing device” and “the presence of a numeric keypad”.

3. The method of claim 2, further comprising notifying, by the terminal, the server of a reference request to the link corresponding to the number input while the modified Web page is displayed.

4. The method of claim 3, wherein the number of digits of the number is fixed, and
in the notifying, the terminal notifies the server of the reference request to the link corresponding to the number of the fixed number of digits.

5. The method of claim 3, wherein the number of digits of the number is variable, and
in the notifying, the terminal notifies the server of the reference request to the link corresponding to the number of the variable number of digits when a prescribed interval has elapsed during operation of the numeric keypad for the number input.

6. The method of claim 3, which further comprises displaying, by the server, a number input box on the modified Web page, and
in which in the notifying, the terminal notifies the server of the reference request to the link corresponding to the number input to the number input box.

7. The method of claim 1, further comprising notifying, by the terminal, the server as an access destination of characteristics of a user interface of the terminal.

8. The method of claim 1, which further comprises storing, by the server, a management database which associates an identifier of a terminal with characteristics of a user interface of the terminal, and
in which the determining includes:
referring, by the server, to the management database using an identifier of an access source terminal as a key; and
determining, by the server, characteristics of a user interface of the access source terminal based on the reference result.

9. The method of claim 1, further comprising:
saving, by the server, the modified Web page; and
transmitting, by the server, the saved modified Web page to an access source terminal having the same characteristics as a transmission destination terminal of the saved modified Web page.

10. A server which stores a Web page accessible from a terminal having a Web page browsing function, comprising:
a determination module configured to determine characteristics of a user interface of an access source terminal;
a generation module configured to generate a modified Web page by modifying a reference method of a link on the Web page according to the determined characteristics; and
a transmitter configured to transmit the modified Web page to the access source terminal.

11. The server of claim 10, wherein the characteristics include the presence/absence of a pointing device and the presence/absence of a numeric keypad, and
the generation module generates a modified Web page that allows reference to the link by a number to be input by the numeric keypad when the determined characteristics indicate “the absence of a pointing device” and “the presence of a numeric keypad”.

12. The server of claim 10, which further comprises a management database which associates an identifier of a terminal with characteristics of a user interface of the terminal, and
in which the determination module refers to the management database using an identifier of an access source terminal as a key, and determines characteristics of a user interface of the access source terminal.

13. The server of claim 10, which further comprises a saving module configured to save the modified Web page, and
in which the transmitter transmits the saved modified Web page to an access source terminal having the same characteristics as a transmission destination terminal of the saved modified Web page.
